(19) United States
(12) Patent Application Publication
(10) Pub. No.: US 2016/0180315 A1
(43) Pub. Date: Jun. 23, 2016

(54) INFORMATION PROCESSING APPARATUS USING OBJECT RECOGNITION, AND COMMODITY IDENTIFICATION METHOD BY THE SAME

(71) Applicant: TOSHIBA TEC KABUSHIKI KAISHA, Tokyo (JP)

(72) Inventor: Keiko Kanamori, Numazu Shizuoka (JP)

(21) Appl. No.: 14/579,233

(22) Filed: Dec. 22, 2014

(51) Int. Cl. G06Q 20/20; G10L 15/22; G06K 9/62; G01G 19/00; G06K 9/00

(52) U.S. Cl. CPC G06Q 20/208; G01G 19/00; G06K 9/00624; G06K 9/6215; G06K 9/6202; G10L 15/22

(57) ABSTRACT

In general, according to one embodiment, an information processing apparatus comprises a first candidate determination section configured to determine at least one commodity serving as a candidate through an image recognition technology on an image obtained by photographing a commodity; a second candidate determination section configured to determine at least one commodity serving as a candidate according to an input speech of the commodity through a speech recognition technology; a weighting processing section configured to carry out weighting on a weighting value of the at least one candidate commodity determined by the first candidate determination section and a weighting value of the at least one candidate commodity determined by the second candidate determination section; and a specification processing section configured to specify the photographed commodity based on the weighting value of the candidate commodity weighted by the weighting processing section.

### FIELD

Embodiments described herein relate generally to an information processing apparatus which uses object recognition, and a commodity identification method by the information processing apparatus.

### BACKGROUND

Conventionally, there is a system in which a commodity is determined through speech recognition or image recognition in a case of determining the commodity at the time of settlement process of the purchased commodity in a checkout system (POS).

In a checkout system which determines a commodity through the speech recognition, an operator reads the commodity through speech, and the checkout system recognizes the speech. Then in a case in which there is a candidate of the commodity, the checkout system indicates a commodity serving as a candidate to the operator, and receives a selection of the operator to specify the commodity (for example, see Japanese Unexamined Patent Application Publication No. 2009-163528).

Further, in a checkout system which determines a commodity through the image recognition, the checkout system recognizes the commodity using a captured image. In a case in which there is a candidate of the commodity, the checkout system indicates a commodity serving as a candidate to the operator, and then receives a selection of the operator to specify the commodity (for example, see Japanese Unexamined Patent Application Publication No. 2013-210971).

However, there is a case in which the commodity cannot be recognized correctly through the conventional speech recognition and image recognition.

For example, the commodity cannot be recognized correctly in a case in which the speech cannot be recognized correctly, a case in which there is a problem in the captured image such as that the hand of the operator is contained in the captured image, or a case in which an identification dictionary for the speech recognition or an identification dictionary for the image recognition is not enhanced. On the other hand, if the identification dictionary is enhanced, it may lead to a problem that more time is taken in the commodity identification.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram illustrating the appearance of a checkout system (POS system) 1;

FIG. 2 is a block diagram illustrating the hardware constitution of a POS terminal 11 and a commodity reading device 101;

FIG. 3 is a conceptual diagram illustrating an example of the data arrangement of a PLU file F1;

FIG. 4 is a diagram illustrating an acoustic dictionary F2-1;

FIG. 5 is a diagram illustrating a speech dictionary F2-2;

FIG. 6 is a diagram illustrating a commodity category/commodity data dictionary F2-3;

FIG. 7 is a flowchart illustrating a first commodity identification method;

FIG. 8 is a flowchart illustrating operations for determining a commodity serving as a candidate through image recognition;

FIG. 9 is a diagram illustrating the relation between a commodity ID and a similarity degree;

FIG. 10 is a diagram illustrating one example of weighting values based on feature amounts of images;

FIG. 11 is a flowchart illustrating operations for determining a commodity serving as a candidate through speech recognition;

FIG. 12 is a diagram illustrating one example of weighting based on speech recognition processing;

FIG. 13 is a flowchart illustrating a second commodity identification method;

FIG. 14 is a diagram illustrating the relation between the commodity ID and the weight of a commodity; and

FIG. 15 is a diagram illustrating one example of weighting values based on weight ratios.

### DETAILED DESCRIPTION

In general, according to one embodiment, an information processing apparatus comprises a first candidate determination section configured to determine at least one commodity serving as a candidate through an image recognition technology on an image obtained by photographing a commodity; a second candidate determination section configured to determine at least one commodity serving as a candidate according to an input speech of the commodity through a speech recognition technology; a weighting processing section configured to carry out weighting on a weighting value of the at least one candidate commodity determined by the first candidate determination section and a weighting value of the at least one candidate commodity determined by the second candidate determination section; and a specification processing section configured to specify the photographed commodity based on the weighting value of the candidate commodity weighted by the weighting processing section.

Hereinafter, a checkout system according to the embodiment is described.

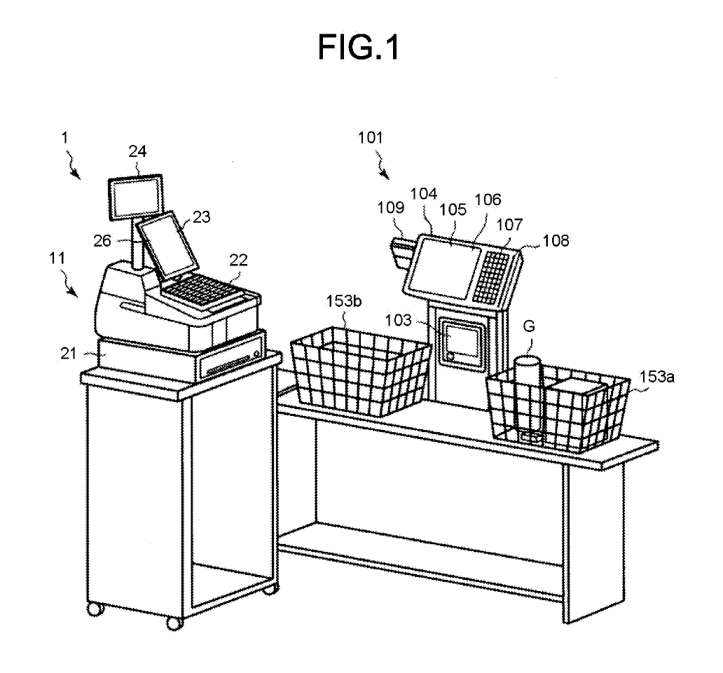

FIG. 1 is a diagram illustrating the appearance of a checkout system (POS system) 1.

As shown in FIG. 1, the checkout system 1 includes a commodity reading device 101 for reading information relating to the commodity and a POS terminal 11 for registering and settling commodities in one transaction.

It is exemplified in the embodiment that the POS terminal 11 executes the commodity identification method according to the embodiment; however, it is not limited to this. The commodity reading device 101 may execute the commodity identification method according to the embodiment; alternatively, both the commodity reading device 101 and the POS terminal 11 may cooperate with each other to carry out the processing relating to the commodity identification method according to the embodiment.

The POS terminal 11 includes a drawer 21, a keyboard 22, a display device 23, a display for customer 24 and the like. On the display screen of the display device 23 is arranged a touch panel 26 through which an input to the POS terminal 11 can be carried out.

The commodity reading device 101 is communicatively connected to the POS terminal 11. The commodity reading device 101 is equipped with a reading window 103 and a display and operation section 104.

A display device 106 serving as a display section on the surface of which is laminated a touch panel 105 is arranged in the display and operation section 104. A keyboard 107 is arranged at the right side of the display device 106. A card reading slit 108 of a card reader (not shown) is arranged at the right side of the keyboard 107. At the left side of the backside of the display and operation section 104 seen from the operator is arranged a display for customer 109 for providing information to a customer.

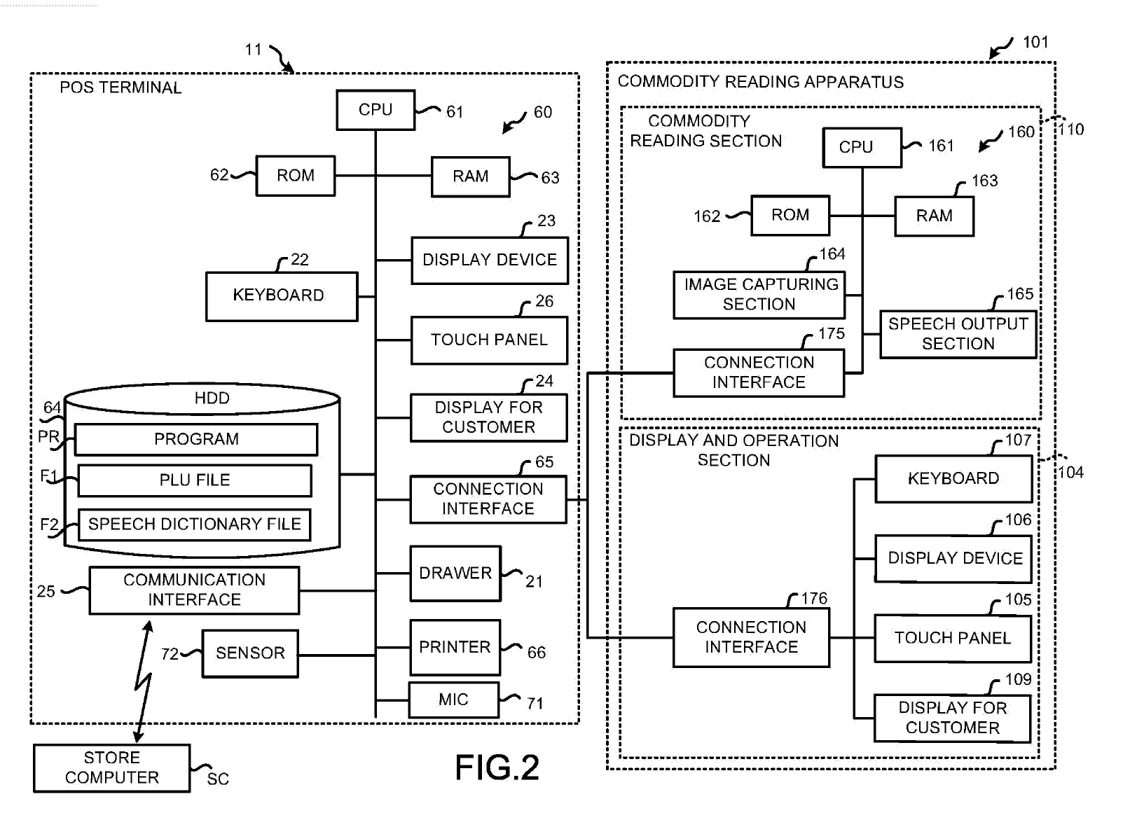

Such a commodity reading device 101 includes a commodity reading section 110 (refer to FIG. 2). The commodity reading section 110 is provided with an image capturing section 164 (refer to FIG. 2) at the rear side of the reading window 103. Commodities G in one transaction are placed in a first shopping basket 153a which is taken to the register counter by the customer. The commodities G placed in the first shopping basket 153a are moved one by one to a second shopping basket 153b by the operator operating the commodity reading device 101. In the moving process, the commodity G is directed to the reading window 103 of the commodity reading device 101. At this time, the image capturing section 164 (refer to FIG. 2) arranged behind the reading window 103 photographs the commodity G to capture an image.

The commodity reading device 101 sends the image captured by the image capturing section 164 to the POS terminal 11. The POS terminal 11 receives the commodity image sent from the commodity reading device 101.

The POS terminal 11 carries out a commodity identification processing according to the later-described embodiment using speech and weight input to the POS terminal 11 and the received commodity image to specify the commodity (commodity ID).

In the POS terminal 11, information relating to sales registration such as commodity category, commodity name, unit price and the like of a commodity specified with the commodity ID specified in the commodity identification processing according to the embodiment is recorded in a sales master file (not shown) and the like to carry out sales registration.

FIG. 2 is a block diagram illustrating the hardware constitution of the POS terminal 11 and the commodity reading device 101. The POS terminal 11 includes a microcomputer 60 serving as an information processing section for executing information processing. The microcomputer 60 is constituted by connecting, through a bus line, a ROM (Read Only Memory) 62 and a RAM (Random Access Memory) 63 with a CPU (Central Processing Unit) which controls each section to execute various arithmetic processing.

The ROM 62 stores programs used for executing processing relating to the commodity identification method of the embodiment executed by the CPU 61. The RAM 63 is used as a work area of the programs for executing the commodity identification method.

The programs for executing the commodity identification method according to the embodiment are not limited to be stored in the ROM 62. For example, the programs may be stored in a HDD 64 of the POS terminal 11, or an external storage device (HDD, USB and the like).

The CPU 61 of the POS terminal 11 is connected with any of the foregoing drawer 21, the keyboard 22, the display device 23, the touch panel 26 and the display for customer 24 through various input/output circuits (none is shown). All these sections are under the control of the CPU 61.

The HDD 64 (Hard Disk Drive) is connected with the CPU 61 of the POS terminal 11. Programs and various files are stored in the HDD 64. When the POS terminal 11 is started, all or part of the programs and various files stored in the HDD 64 are developed on the RAM 63 to be executed by the CPU 61. A program PR for commodity sales data processing is an example of the program stored in the HDD 64. A PLU file F1 and a speech dictionary file F2 sent from a store computer SC are examples of the files stored in the HDD 64.

The PLU file F1 is used as a dictionary. The PLU file F1 is a commodity file in which the association between the information relating to sales registration of the commodity G and the image of the commodity G is set for each of the commodities G displayed and sold in the store.

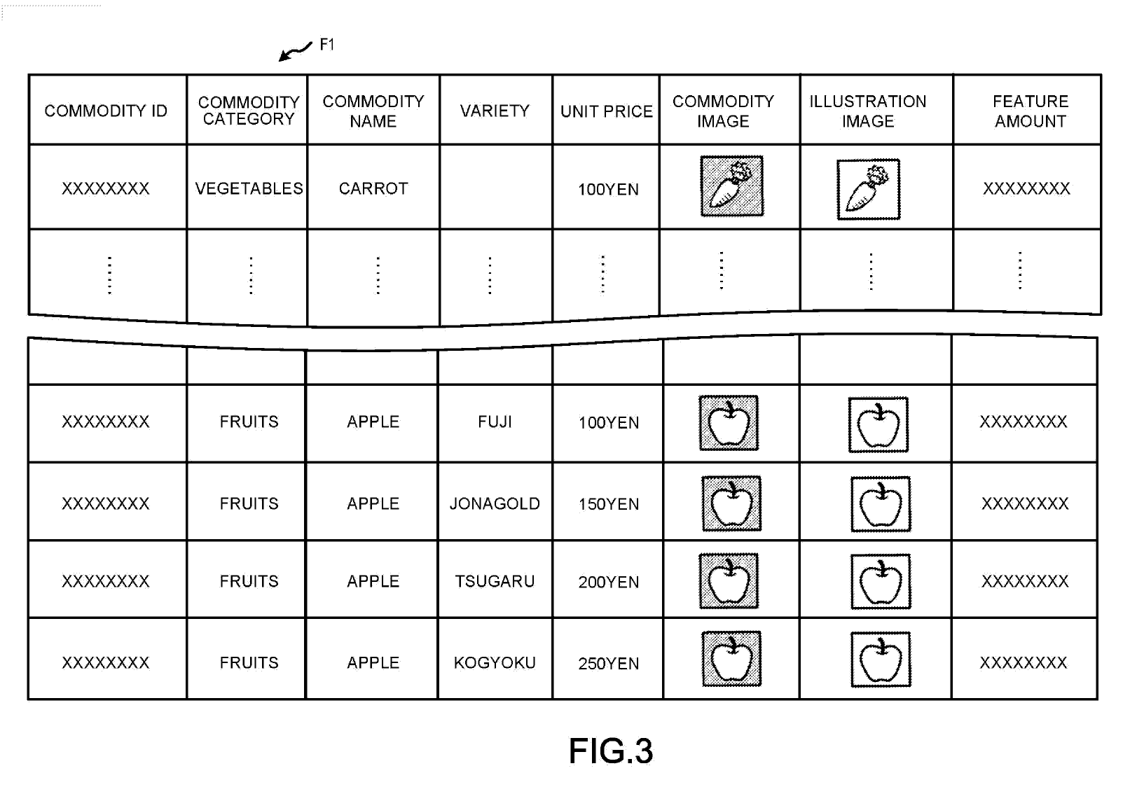

FIG. 3 is a conceptual diagram illustrating an example of the data arrangement of the PLU file F1. The PLU file F1 stores commodity information for each commodity G. As shown in FIG. 3, the commodity information is stored in such a manner that the information relating to the commodity such as the commodity category to which the commodity G belongs, a commodity name, a unit price and the like is associated with a commodity ID uniquely assigned to the commodity. Further, a commodity image (reference image) obtained by photographing the commodity, an illustration image indicating the commodity, a feature amount such as the tint and surface concave-convex state read from the captured commodity image or reference image are stored in association with the commodity ID. The feature amount is used in the later-described similarity degree determination.

In a case in which it is necessary to recognize (detect) not only the category (commodity) of the object but also the variety, the PLU file F1 manages the feature amount and the like for each variety. In the embodiment, as shown in FIG. 3, the information relating to the commodity such as the commodity name, the unit price and the like, the commodity image (reference image) obtained by photographing the commodity, the illustration image indicating the commodity and the feature amount are managed for each variety.

For example, in a case in which the category (commodity) of the object is “apple”, the information relating to the commodity such as the commodity name, the unit price and the like is manages for each variety such as “Fuji” “Jonagold” “Tsugaru” and “Kogyoku”. Further, the commodity image (reference image) obtained by photographing the commodity, the illustration image indicating the commodity and the feature amount are managed for each variety.

The speech dictionary file F2 is used for carrying out speech recognition according to the embodiment.

The speech dictionary file F2 includes an acoustic dictionary F2-1, a speech dictionary F2-2 and a commodity category/commodity data dictionary F2-3. The acoustic dictionary F2-1 stores speech feature amount vectors and speech pattern data in an associated manner. The speech dictionary F2-2 stores speech pattern data and commodity category/character string in an associated manner. The commodity, category/commodity data dictionary F2-3 stores commodity category and commodity data (commodity ID, commodity name) in an associated manner.

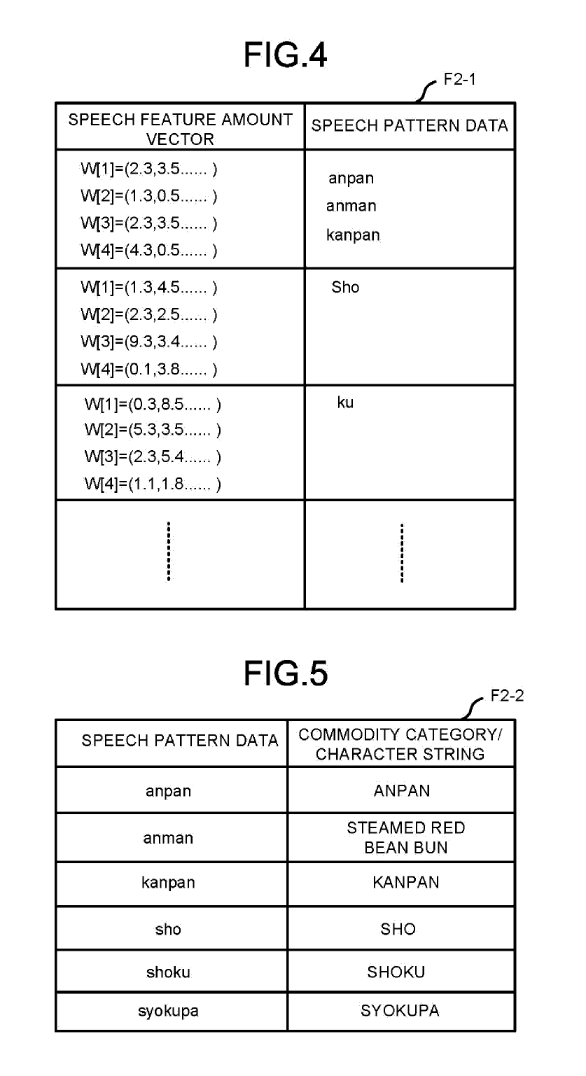

The acoustic dictionary F2-1 shown in FIG. 4 associates the speech feature amount of the speech with the speech pattern data. For example, in a case in which the operator utters the word “anpan”, the speech feature amount vector of the speech is W1[1] shown in FIG. 4. Then the speech pattern data corresponding to the feature amount vector W1[1] is stored as “anpan” in an associated manner. Next, the speech pattern data in which the reading of the speech when a predetermined phrase is uttered is recorded is stored in the speech dictionary F2-2 shown in FIG. 5. Herein, the speech pattern data refers to the pronunciation of each commodity category. The speech pattern data and the commodity category are stored in an associated manner, and the commodity category indicated by the input speech can be recognized according to the speech dictionary F2-2.

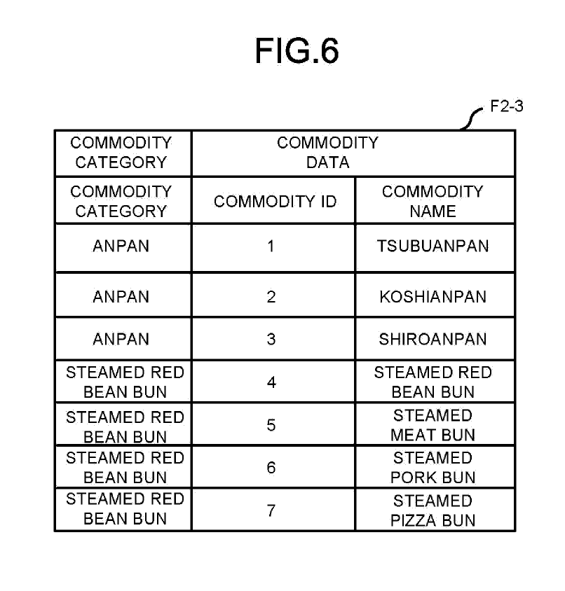

The commodity category/commodity data dictionary F2-3 stores the commodity data for identifying the commodity and the commodity category set corresponding to the commodity data. FIG. 6 is a diagram illustrating the data content stored in the commodity category/commodity data dictionary F2-3. As shown in FIG. 6, the commodity category, the commodity ID and the commodity name as the commodity data are stored as the data, and the same commodity category is set for the commodity names which are classified into the same commodity category.

Return to FIG. 2. The CPU 61 of the POS terminal 11 is connected with a communication interface 25 through an input/output circuit (not shown) to execute data communication with the store computer SC. The store computer SC is arranged in the back office and the like of the store. The FLU file F1 sent from the POS terminal 11 is stored in a HDD (not shown) of the store computer SC.

The CPU 61 of the POS terminal 11 is connected with a connection interface 65 to be capable of carrying out data transmission/reception with the commodity reading device 101. The connection interface 65 is connected with the commodity reading device 101. A receipt printer 66 which carries out printing on a receipt and the like is connected with the CPU 61 of the POS terminal 11. The receipt printer 66 prints content of one transaction on a receipt under the control of the CPU 61.

The CPU 61 is further connected with a MIC 71 for inputting the speech from the operator and a weight sensor 72. The weight sensor 72, which detects the weight of the first shopping basket 153a taken to the register table by the customer, is arranged on, for example, a placement table where the first shopping basket 153a is placed. In addition, no specific limitation is given to the position of the weight sensor 72 as long as it can calculate the weight of the commodity, thus, the weight sensor 72 may be arranged on a placement table where the second shopping basket 153b is placed.

In a case in which the weight sensor 72 detects the weight of the first shopping basket 153a, the weight obtained by subtracting the weight of the first shopping basket 153a the commodities in which are removed from the weight of the first shopping basket 153a in which the commodities are placed is calculated as the weight of the commodities. In a case in which the weight sensor 72 detects the weight of the second shopping basket 153b, the weight obtained by subtracting the weight of the second shopping basket 153b in which no commodity is placed from the weight of the second shopping basket 153b in which the commodities are placed is calculated as the weight of the commodities.

The commodity reading device 101 is also equipped with a microcomputer 160. The microcomputer 160 is constituted by connecting a ROM 162 and a RAM 163 with a CPU 161 through a bus line. The ROM 162 stores programs used for executing processing relating to the commodity identification method of the embodiment executed by the CPU 161.

The RAM 163 is used as a work area of the programs for executing the commodity identification method.

The CPU 161 is connected with the image capturing section 164 and a speech output section 165 through various input/output circuits (none is shown). The operations of the image capturing section 164 and the speech output section 165 are controlled by the CPU 161. The display and operation section 104 is connected with the commodity reading section 110 and the POS terminal 11 through a connection interface 176. The operations of the display and operation section 104 are controlled by the CPU 161 of the commodity reading section 110 and the CPU 61 of the POS terminal 11.

The image capturing section 164, which is a color CCD image sensor or a color CMOS image sensor and the like, is an image capturing module for carrying out an image capturing processing through the reading window 103 under the control of the CPU 161. For example, motion images are captured by the image capturing section 164 at 30 fps. The frame images (captured images) sequentially captured by the image capturing section 164 at a predetermined frame rate are stored in the RAM 163.

The speech output section 165 includes a speech circuit and a speaker and the like for issuing a preset alarm sound and the like. The speech output section 165 gives a notification through a speech or an alarm sound under the control of the CPU 161.

Further, a connection interface 175 which is connected with the connection interface 65 of the POS terminal 11 and enables the data transmission/reception with the POS terminal 11 is connected with the CPU 161. The CPU 161 carries out data transmission/reception with the display and operation section 104 through the connection interface 175.

Next, the commodity identification method in the information processing apparatus according to the embodiment is described.

The commodity identification method according to the embodiment is realized by the CPU 61 of the POS terminal 11 which executes the programs stored in the ROM 62. However, part of the processing may be carried out by the CPU 161 of the commodity reading device 101.

(First Commodity Identification Method)

The first commodity identification method carries out commodity identification using both an image recognition processing technology and a speech recognition processing technology.

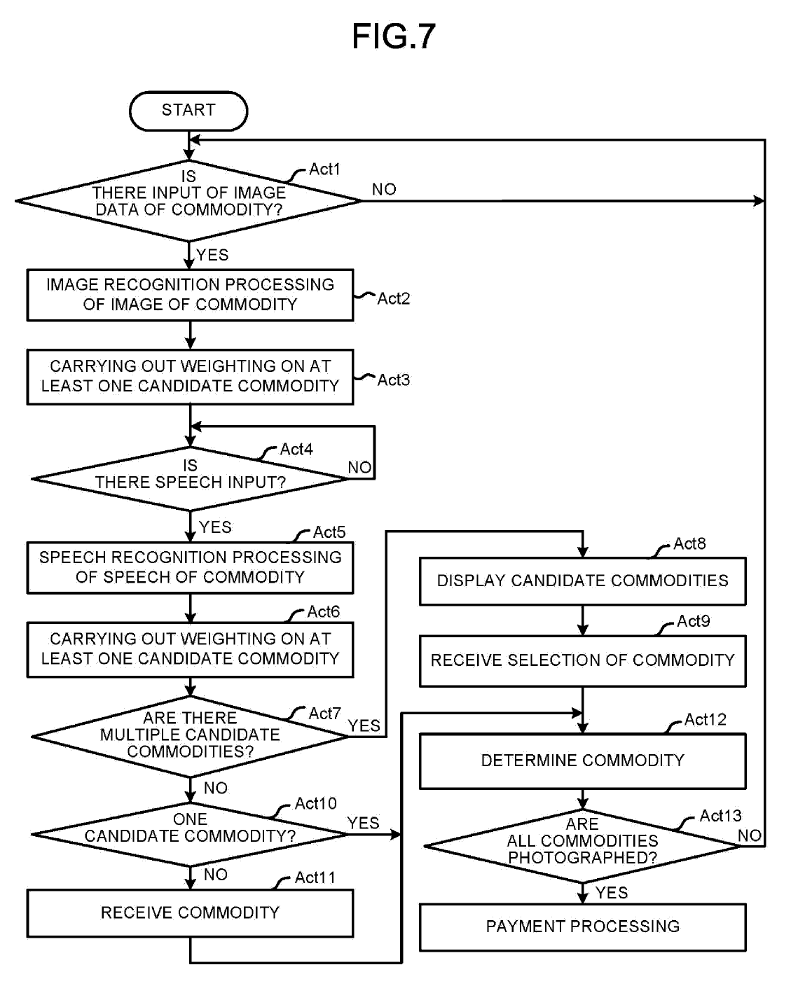

FIG. 7 is a flowchart illustrating the first commodity identification method.

When the operator holds a commodity over the reading window 103, the image capturing section 164 photographs the commodity to capture an image. The image data obtained from the image captured by the image capturing section 164 is stored in the RAM 163. Then the image data is sent to the POS terminal 11 through the connection interface 175 of the commodity reading device 101 and the connection interface 65 of the POS terminal 11.

The CPU 61 determines whether or not the image data of the commodity is input (ACT 1). Specifically, the CPU 61 determines whether or not the image data sent to the POS terminal 11 is received. The image data sent to the POS terminal 11 is stored in the RAM 63.

In a case in which it is determined in ACT 1 that the image data of the commodity is input, the image recognition processing of the image of the commodity is carried out to determine at least one commodity serving as a candidate (ACT 2).

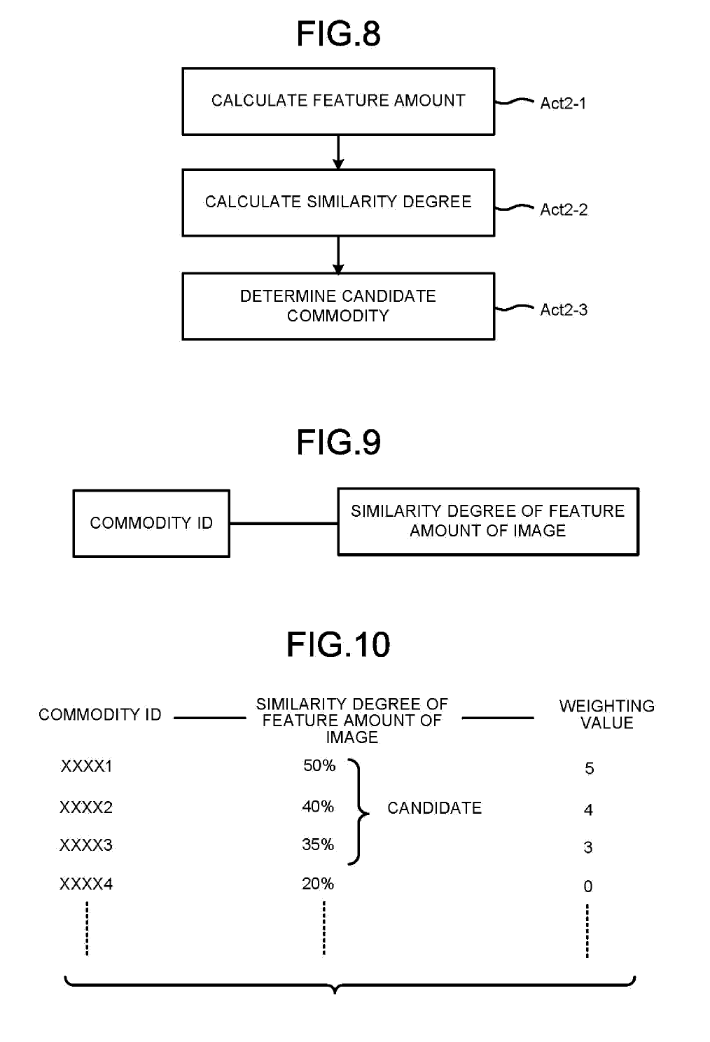

The technology for specifying at least one commodity serving as a candidate from the image of the commodity uses an object recognition technology, and various methods are considered. FIG. 8 is a flowchart illustrating the operations for specifying the commodity serving as a candidate through the image recognition.

The CPU 61 calculates a feature amount from the color information and texture information of the stored image data (ACT 2-1). Herein, the feature amount calculation from the image data is a technology generally carried out in the checkout system.

In a case of extracting the feature amount of the commodity image from the image data, a technology in which the area of a hand of the operator and the like is removed in advance from the image using infrared ray image and then the feature amount of the image data is extracted more correctly may be used.

Next, the CPU 61 compares the feature amount calculated in ACT 2-1 with the feature amount of each commodity ID by reference to the PLU file F1 stored in the HDD 64 of the POS terminal 11. Then the similarity degree of the feature amount of the photographed commodity with the feature amount of each commodity ID is calculated (ACT 2-2). As shown in FIG. 9, the calculated similarity degree is stored in the RAM 63 in association with the commodity ID. Further, the calculated similarity degree may be stored in the HDD 64 of the POS terminal 11.

The commodity (commodity ID) of which the similarity degree is greater than a predetermined threshold value (predetermined similarity degree) within the similarity degrees of the feature amounts of the photographed commodities with the feature amount of each commodity ID calculated in ACT 2-2 is determined as a candidate (ACT 2-3). In a case in which there is no commodity of which the similarity degree is greater than the predetermined threshold value (predetermined similarity degree), it is determined that there is no candidate commodity, and the processing in ACT 4 is executed.

In this way, in a case in which at least one commodity serving as a candidate is determined in ACT 2, a weighting operation is carried out for the at least one commodity serving as a candidate (ACT 3). Specifically, each commodity ID has a weighting value. A weighting value according to the similarity degree is added to the weighting value of the commodity (commodity ID) serving as a candidate.

FIG. 10 is a diagram illustrating one example of the weighting values based on the feature amounts of the images.

For example, in a case in which the standard of the candidate commodity is a similarity degree higher than 30%, in the example shown in FIG. 10, the commodities XXXX1-XXXX3 are candidates, while the commodity XXXX4 is not a candidate. Then, the weighting values according to the similarity degrees are added to the weighting values of the commodities XXXX1-XXXX3, respectively.

In the example in FIG. 10, values 5, 4, 3 are added to the commodities XXXX1, XXXX2 and XXXX3, respectively. In addition, the weighting value and the weighting method are not limited to this.

After the processing in ACT 3 is carried out, the CPU 61 determines whether or not there is a speech input (ACT 4). Specifically, as to the acquisition of the speech, when the operator utters the commodity name towards the MIC 71, the speech data is stored in the RAM 63.

If it is determined that there is a speech input, the speech recognition processing of the commodity is carried out to determine at least one commodity serving as a candidate (ACT 5).

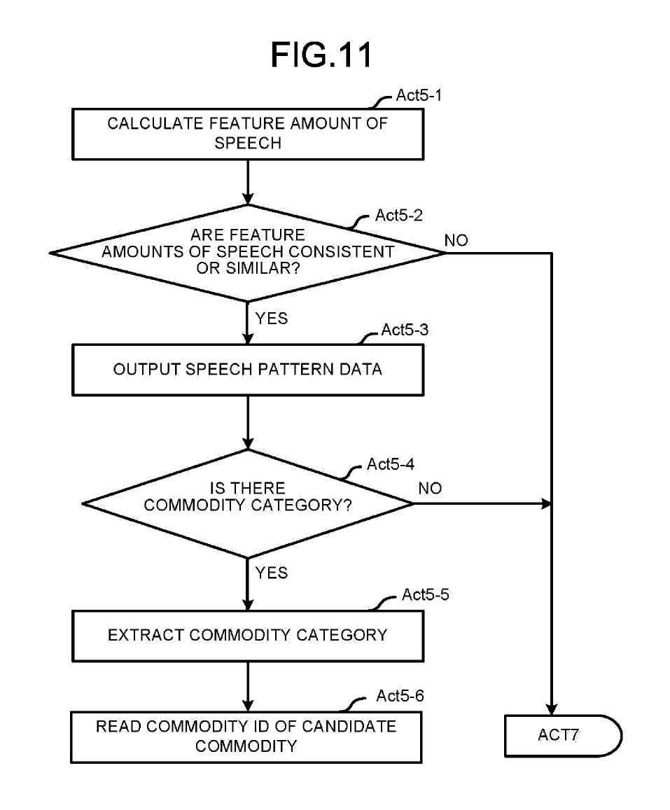

Various technologies are considered as the technology for specifying at least one commodity serving as a candidate according to the speech of the commodity. In the embodiment, a case of extracting a commodity serving as a candidate using the concept of the “category” of the commodity is described. FIG. 11 is a flowchart illustrating an operation of determining a commodity serving as a candidate through the speech recognition.

First, the feature amount of the input speech is calculated (ACT 5-1.) Next, the speech feature amount of the input speech is compared with pre-created speech feature amount by reference to the acoustic dictionary F2-1 to determine whether or not the two speech feature amounts are consistent or similar (ACT 5-2).

In a case in which the speech feature amount of the input speech is not consistent with or similar to the pre-created speech feature amount, the processing in ACT 7 is executed. On the other hand, in a case in which the speech feature amount of the input speech is consistent with or similar to the pre-created speech feature amount, the speech pattern data stored in association with the consistent or similar speech feature amount is output by reference to the acoustic dictionary F2-1 based on the speech feature amount (ACT 5-3).

Next, it is determined whether or not there is a commodity category stored in association with the speech pattern data by reference to the speech dictionary F2-2 based on the output speech pattern data (ACT 5-4). For example, it is assumed that the speech pattern data is “anpan” and “anman”. The speech pattern data is compared with the speech pattern data stored in the speech dictionary F2-2.

In a case in which the output speech pattern data does not exist in the speech pattern data in the speech dictionary F2-2 by reference to the speech dictionary F2-2, the processing in ACT 7 is executed. On the other hand, in a case in which the output speech pattern data exists in the speech dictionary F2-2, the commodity category is extracted based on the output speech pattern data (ACT 5-5).

For example, it is assumed that the speech pattern data “anpan” and “anman” consistent with the output speech pattern data is pre-stored in the speech dictionary F2-2 to be referred to. In this case, two commodity categories “anpan” and “steamed red bean bun” associated with the speech pattern data “anpan” and “anman” are extracted as the candidates.

Next, the commodity ID of at least one commodity serving as a candidate set corresponding to the commodity category is read from the commodity category/commodity data dictionary F2-3 (ACT 5-6).

In this way, after at least one commodity (commodity ID) serving as a candidate is determined in ACT 5, weighting is carried out for the at least one commodity serving as a candidate (ACT 6).

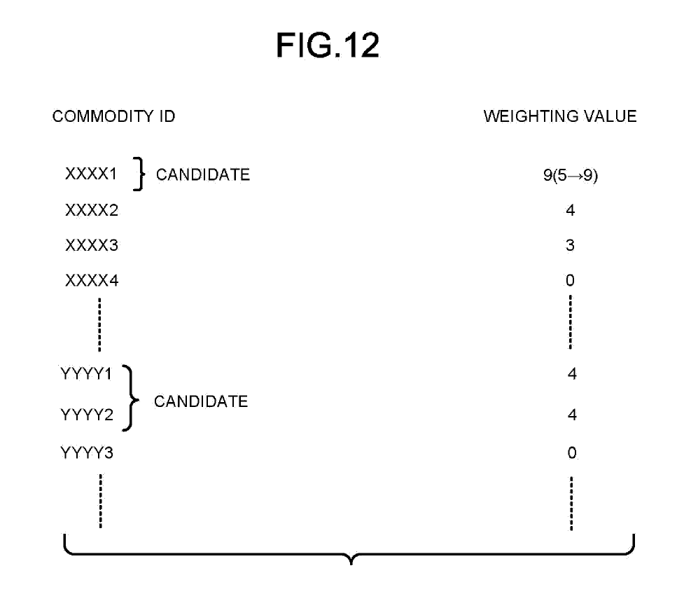

FIG. 12 is a diagram illustrating one example of the weighting based on the speech recognition processing.

As shown in FIG. 12, in a case of carrying out weighting on the commodity ID, commodities XXXX1, YYYY1 and YYYY2 are determined as the commodity (commodity ID) serving as candidates in ACT 5-6.

In a case in which a value “4” is added to each weighting value of the commodities serving as candidates determined through the speech recognition processing, as shown in FIG. 12, the new weighting values of the commodities XXXX1, YYYY1 and YYYY2 after the weighting become 9, 4 and 4. In addition, the weighting value and the weighting method are not limited to this.

Next, it is determined whether or not there is a plurality of candidate commodities (ACT 7).

The standard of the candidate is based on the weighting value associated with each commodity ID.

For example, in FIG. 12, in a case in which the standard value of the weighting value of the candidate is equal to or greater than 4, the commodities XXXX1, XXXX2, YYYY1 and YYYY2 become the candidate commodities.

Thus, compared with a case of determining the commodity only through the image recognition processing or the speech recognition processing, the commodity can be specified more correctly in a case of determining the candidate commodity based on a standard of the weighting value.

In ACT 7, if it is determined that there is a plurality of candidate commodities, the candidate commodities are displayed on the display device 106 (ACT 8). Then a selection of commodity from the displayed candidate commodities by the user is received (ACT 9).

On the other hand, if it is determined that there are no multiple candidate commodities in ACT 7, it is determined whether or not there is one candidate commodity (ACT 10). If it is determined that there is no one candidate commodity in ACT 10, there is no commodity serving as a candidate, thus, the commodity is received from the user (ACT 11).

Next, the commodity is determined in ACT 12.

Specifically, in a case in which the selection of the commodity is received in ACT 9, the selected commodity is determined. In a case in which it is determined that there is one candidate commodity in ACT 10, the candidate commodity is determined. In a case in which a commodity is received from the user in ACT 11, the received commodity is determined.

Next, it is determined whether or not all the commodities are photographed (ACT 13). If it is determined that all the commodities are photographed, the payment processing based on the determined commodity ID is executed. On the other hand, if it is determined that all the commodities are not photographed, the processing in ACT 1 is carried out again.

Thus, according to the first commodity identification method, two unrelated kinds of information (that is, the commodity name and the appearance) can be combined to carry out the commodity identification correctly. As a result, a commodity serving as a candidate can be extracted correctly.

(Second Commodity Identification Method)

In the second commodity identification method, the weight of the commodity is also taken into consideration to carryout commodity identification, in addition to the first commodity identification method.

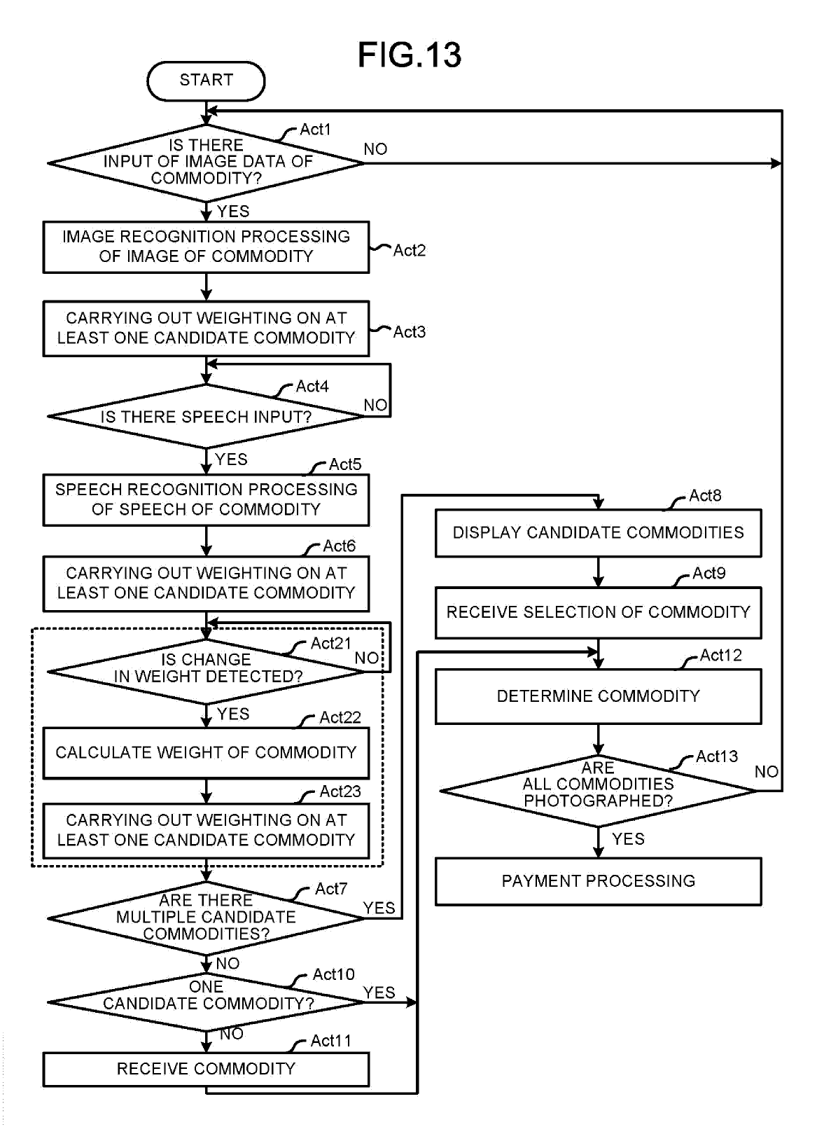

FIG. 13 is a flowchart illustrating the second commodity identification method. In addition, the processing from ACT 1 to ACT 13 is the same as that shown in FIG. 7, thus, the derailed description is not provided repeatedly.

In ACT 1-ACT 6, the weighting processing based on the image recognition and the weighting processing based on the speech recognition processing are carried out. After the processing in ACT 6 is carried out, it is detected by the weight sensor 72 whether or not the weight of the first shopping basket 153a is changed (ACT 21).

If it is detected that the weight is changed, the CPU calculates the weight of the commodity (ACT 22). Specifically, the change part of the weight indicates the weight of the commodity, thus, in a case of detecting the weight of the first shopping basket 153a, the weight obtained by subtracting the weight of the first shopping basket 153a the commodities in which are removed from the weight of the first shopping basket 153a in which the commodities are placed is calculated as the weight of the commodities.

Next, weighting is carried out for at least one commodity serving as a candidate (ACT 23).

Specifically, the weighting based on the weight is carried out as follows.

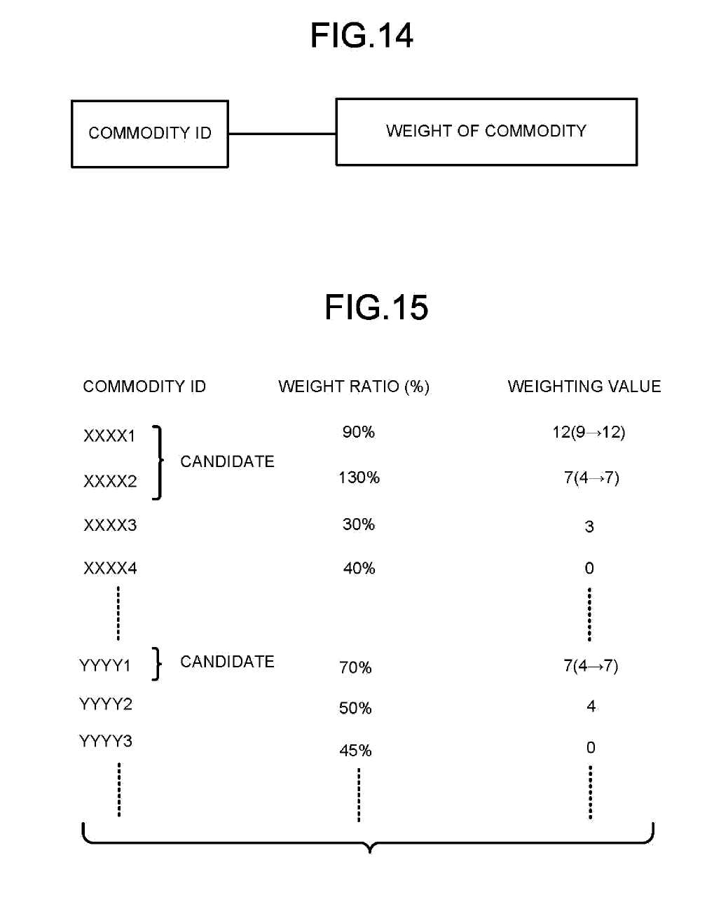

In the second commodity identification method, as shown in FIG. 14, the general weight of the commodity indicated by the commodity ID is stored in association with each commodity ID.

The CPU 61 calculates a ratio (percent) of the calculated commodity weight to the pre-stored commodity weight for each commodity. Then a commodity having a weight ratio meeting a predetermined standard within the calculated weight ratios is taken as a candidate.

Next, the CPU 61 adds a predetermined value to the weighting value of the candidate commodity to carry out weighting processing. In addition, the weighting value and the weighting method are not limited to this. For example, the weighting value may vary according to the magnitude of the weight ratios.

FIG. 15 is a diagram illustrating one example of weighting values based on the weight ratios.

For example, in a case in which the standard of the candidate commodity is that the weight ratio is in a range of ±30%, the commodities XXXX1, XXXX2 and YYYY1 are taken as the candidates in the example shown in FIG. 15.

As shown in FIG. 12, if a value “3” is added to each weighting value in a case of carrying out weighting on the commodity ID, the new weighting values of the commodities XXXX1, XXXX2 and YYYY1 after the weighting become 12, 7 and 7 as shown in FIG. 15.

Next, it is determined whether or not there is a plurality of candidate commodities (ACT 7). The determination in ACT 7 is carried out according to whether or not the weighting value associated with the commodity ID is equal to or greater than a predetermined standard value. As stated above, not only the similarity degree of the image and the recognition result of the speech recognition but also the weight ratio is reflected in the weighting value. Thus, compared with the first commodity identification method, the commodity can be identified more correctly through the second commodity identification method. Sequentially, as stated in the first commodity identification method, the processing from ACT 8 to ACT 13 is carried out.

It is exemplified that the weighting processing (ACT 21-ACT 23) based on the weight is carried out after the weighting processing (ACT 1-ACT 3) based on the image and the weighting processing (ACT 4-ACT 6) based on the speech, however, it is not limited to this.

The processing order of the weighting processing (ACT 21-ACT 23) based on the weight, the weighting processing (ACT 1-ACT 3) based on the image and the weighting processing (ACT 4-ACT 6) based on the speech can be changed.

It is described in the embodiment that the weighting is carried out for all the commodities serving as candidates determined through the speech recognition processing. However, the precision of the speech recognition is relatively high, thus, the processing of determining the commodity in ACT 12 may be carried out directly in a case in which the candidate is narrowed to one in ACT 5.

It is exemplified that the commodity category is used in the extraction of the candidate commodity through the speech recognition. However, a commodity which simply has the consistent speech pattern may be extracted as the candidate commodity. Further, the weighting value may also vary based on the similarity degree of the speech pattern.

According to the embodiment, great effect can be achieved in the following cases.

For example, in a case of a red and rounded commodity that can hardly be determined to be an apple or a red paprika from the appearance only. However, even in a case of such a commodity, there is a big difference in the speeches of “apple” and “red paprika”, thus, a correct result can be obtained if the extraction result according to the speech data is taken into account. Further, the commodity determination can be carried out with higher precision if the weight is also taken into account.

Similarly, in a case of “croquette” and “mince cutlet” having big difference in size, these two commodities are almost indistinguishable according to the image data; however, the commodity can be specified correctly according to the information of speech data.

The entity for executing the operations may be an entity relating to a computer such as hardware, a complex of hardware and software, software, software that is being executed and the like. The entity for executing the operations is, for example, a process executed in a processor, a processor, an object, an execution file, a thread, a program and a computer; however, it is not limited to this. For example, an information processing apparatus or an application executed by the same may be an entity for executing the operations. A process or a thread may play a part as a plurality of entities for executing the operations. The entity for executing the operations may be arranged in one information processing apparatus or be distributed in a plurality of information processing apparatuses.

Further, the function described above may be pre-recorded in the apparatus. However, the present invention is not limited to this, and the same function may be downloaded to the apparatus from a network. Alternatively, the same function recorded in a recording medium may be installed in the apparatus. The form of the recording medium is not limited as long as the recording medium can store programs like a disk ROM and a memory card and is readable by an apparatus. Further, the function realized by an installed or downloaded program can also be realized through the cooperation with an OS (Operating System) installed in the apparatus.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An information processing apparatus comprising:
a first candidate determination section configured to determine at least one commodity serving as a candidate through an image recognition technology on an image obtained by photographing a commodity;
a second candidate determination section configured to determine at least one commodity serving as a candidate according to an input speech of the commodity through a speech recognition technology;
a weighting processing section configured to carry out weighting on a weighting value of the at least one candidate commodity determined by the first candidate determination section and a weighting value of the at least one candidate commodity determined by the second candidate determination section; and
a specification processing section configured to specify the photographed commodity based on the weighting value of the candidate commodity weighted by the weighting processing section.

2. The information processing apparatus according to claim 1, further comprising:
a calculation section configured to calculate the weight of the photographed commodity; and
a third candidate determination section configured to determine at least one commodity serving as a candidate based on the weight of the commodity calculated by the calculation section; wherein
the weighting processing section further carries out weighting on a weighting value of the at least one candidate commodity determined by the third candidate determination section.

3. The information processing apparatus according to claim 1, wherein
the specification processing section, which includes a final candidate determination section for determining the candidate commodity based on the weighting value of the candidate commodity weighted by the weighting processing section and a selection reception section for receiving, in a case in which there is a plurality of candidate commodities determined by the final candidate determination section, a selection of a commodity from the plurality of candidate commodities, specifies the selected commodity.

4. The information processing apparatus according to claim 3, wherein
the specification processing section further includes a display control section for displaying, in a case in which there is a plurality of candidate commodities determined by the final candidate determination section, the plurality of candidate commodities on a display section.

5. The information processing apparatus according to claim 3, wherein
the specification processing section specifies, in a case in which there is only one candidate commodity determined by the final candidate determination section, the one candidate commodity.

6. The information processing apparatus according to claim 3, wherein
the specification processing section, which further includes a reception section for receiving a commodity instructed from a user in a case in which there is no candidate commodity determined by the final candidate determination section, specifies the commodity received by the reception section.

7. The information processing apparatus according to claim 1, wherein
the specification processing section specifies, in a case in which one candidate commodity is determined by the second candidate determination section, the determined one candidate commodity.

8. The information processing apparatus according to claim 1, wherein
the weighting value of the at least one candidate commodity determined by the first candidate determination section is based on a similarity degree of the image of the photographed commodity with a pre-stored image of the at least one candidate commodity determined by the first candidate determination section.

9. The information processing apparatus according to claim 1, wherein
the weighting of the at least one candidate commodity determined by the second candidate determination section is carried out in a case in which the input speech pattern data of the commodity is consistent with the speech pattern data of category or the pre-stored speech pattern data of the at least one candidate commodity determined by the second candidate determination section.

10. The information processing apparatus according to claim 2, wherein
the weighting value of the at least one candidate commodity determined by the third candidate determination section is based on a weight ratio of the weight of the commodity calculated by the calculation section to the pre-stored weight of the at least one candidate commodity determined by the third candidate determination section.

11. The information processing apparatus according to claim 2, wherein
the calculation section calculates the weight of the photographed commodity by subtracting the weight of a shopping basket the photographed commodity in which is removed from the weight of the shopping basket in which the photographed commodity is placed.

12. The information processing apparatus according to claim 1, wherein
the first candidate determination section compares the feature amount of the image of the photographed commodity with the pre-stored feature amount of the commodity to calculate a similarity degree of images for each commodity, and determines the at least one candidate commodity based on the calculated similarity degree of images.

13. A commodity identification method, including:
determining at least one commodity serving as a candidate through an image recognition technology on an image obtained by photographing a commodity;
determining at least one commodity serving as a candidate according to an input speech of the commodity through a speech recognition technology;
carrying out weighting on a weighting value of the at least one candidate commodity determined using the image recognition technology and a weighting value of the at least one candidate commodity determined using the speech recognition technology; and
specifying the photographed commodity based on the weighting value of the weighted candidate commodity.

14. The commodity identification method according to claim 13, further including:
calculating the weight of the photographed commodity; and
determining at least one commodity serving as a candidate based on the calculated weight of the commodity; wherein
the weighting is carried out on a weighting value of the at least one candidate commodity determined based on the calculated commodity weight.

15. A computer-readable information recording medium for recording programs which enable a computer to execute commodity identification method:
determining at least one commodity serving as a candidate through an image recognition technology on an image obtained by photographing a commodity;
determining at least one commodity serving as a candidate according to an input speech of the commodity through a speech recognition technology;
carrying out weighting on a weighting value of the at least one candidate commodity determined using the image recognition technology and a weighting value of the at least one candidate commodity determined using the speech recognition technology; and
specifying the photographed commodity based on the weighting value of the weighted candidate commodity.

16. The computer-readable information recording medium according to claim 15, wherein
the program further enabling the computer to execute the following processing:
calculating the weight of the photographed commodity; and
determining at least one commodity serving as a candidate based on the calculated weight of the commodity; wherein
the weighting is carried out on a weighting value of the at least one candidate commodity determined based on the calculated commodity weight.
